(19) United States
(12) Patent Application Publication
(10) Pub. No.: US 2002/0093164 A1
(43) Pub. Date: Jul. 18, 2002

(54) Skate cart kickstand

(76) Inventor: Dean Tai, W. Covina, CA (US)

Correspondence Address: Street Boggie, Inc., 2750 Artesia BLVD., Redondo Beach, CA, 90278, US

(21) Appl. No.: 09/760,768

(22) Filed: Jan. 16, 2001

(51) Int. Cl. B62H 1/02

(52) U.S. Cl. 280/87.041; 280/293; 280/763.1

(57) ABSTRACT

A kickstand device for a skate cart attached to a skate cart frame allows a skate cart to stand up. The kickstand can be biased in closed position by springs. The kickstand can also be unfolded into open position where the same springs bias the kickstand in open position. A user rides the skate cart with the kickstand in closed position. When the user wants the skate cart to stand up, the user folds the skate cart kickstand into open position.

### BACKGROUND OF THE INVENTION

1. Field of the Invention

The present invention relates to a kickstand device for skate carts.

2. Description of Related Art

A conventional skate cart generally includes a frame with a front wheel and a rear wheel. A steerer tube is connected to the front wheel and a handlebar assembly is connected to the steerer tube so that when rotating the handlebar assembly, the skate cart turns accordingly. A conventional brake device is employed to stop the rear wheel and the brake device is similar to that of a bicycle.

Conventional skate carts are also designed to fold up, collapse and be carried by a user. In between rides, a user who does not wish to collapse a conventional skate cart must lay it on the ground or lean it against a wall. This inevitably scratches the conventional skate cart and is not desired.

### SUMMARY OF THE INVENTION

The invention is a kickstand device for a skate cart wherein a kickstand is attached to the skate cart frame. The kickstand can be biased in closed position by two springs. It can also be unfolded into open position where the same two springs bias the kickstand in open position. A user rides the skate cart with the kickstand in closed position. When the user wants the skate cart to stand up, the user folds the skate cart kickstand into open position.

### BRIEF DESCRIPTION OF THE DRAWINGS

FIG. 1 is a perspective view of the device in open position.

FIG. 2 is a side view of the device in open position showing the front portion of the skate cart.

FIG. 3 is a front view of the device in open position.

FIG. 4 is a side view of the device showing open and closed positions.

### DESCRIPTION OF THE PREFERRED EMBODIMENT

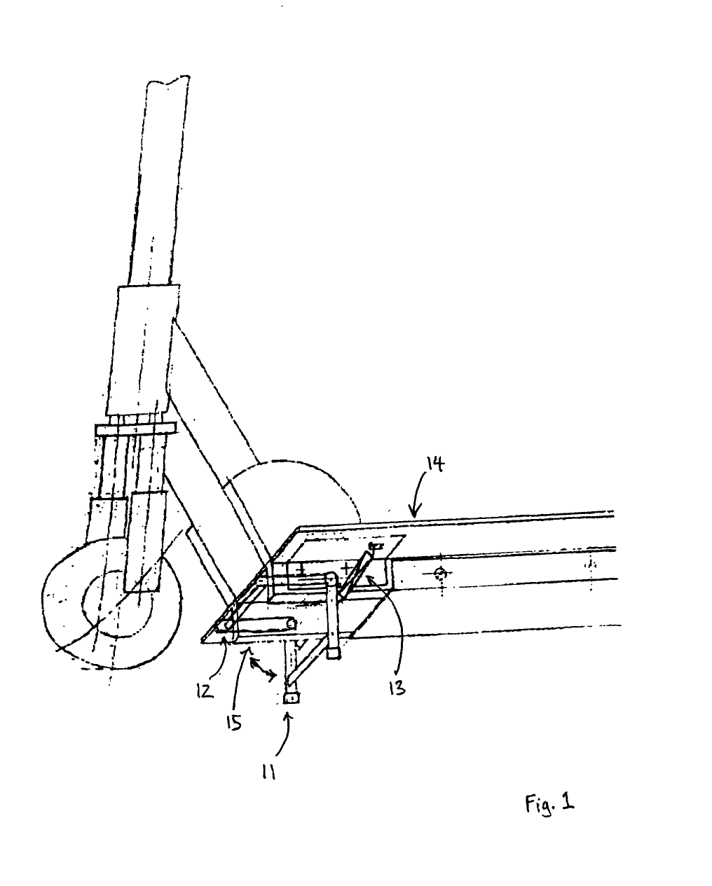

A kickstand is best implemented on a skate cart FIG. 1, with a U shaped support rail 15. The support rail 15 is U shaped and can receive a kickstand mounting on its inside or on its outside. The user stands on a deck 14, which is supported by the support rail 15. The U shaped support rail 15 allows a space to mount a kickstand 11.

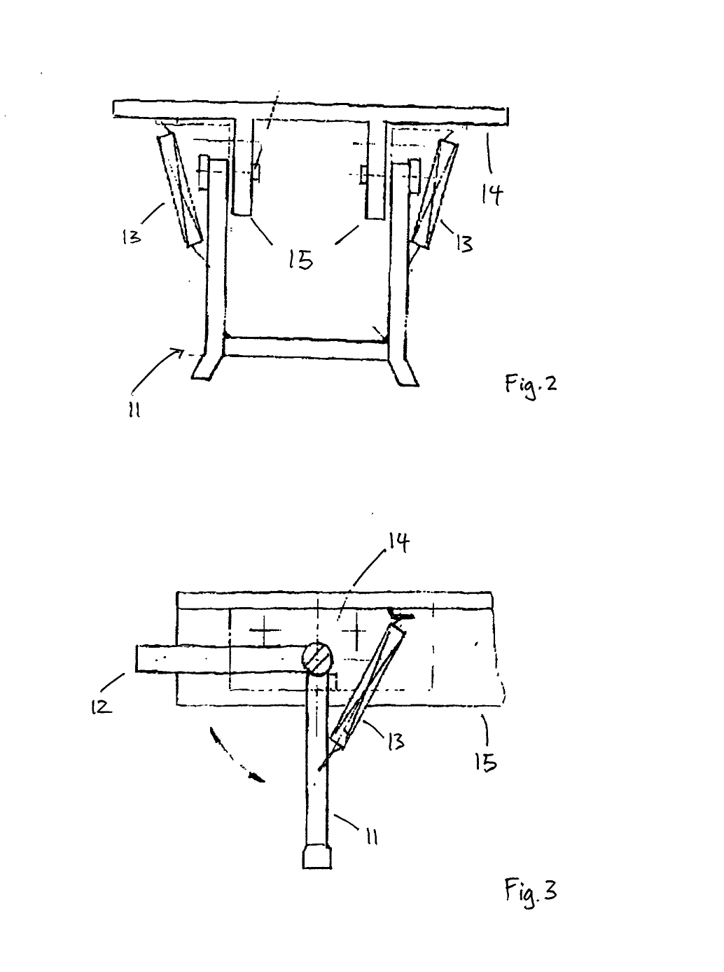

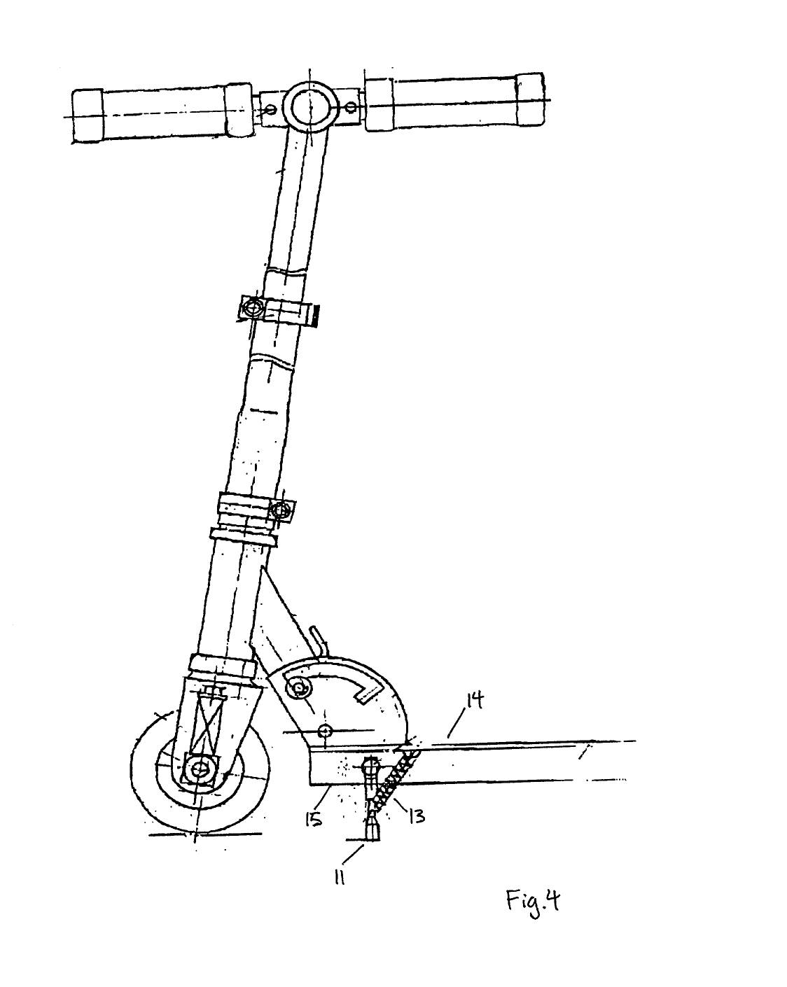

In FIG. 1, 2, 3 and 4 the kickstand is in open position where two coil springs hold the kickstand open. The kickstand is shown as being mounted on the outer edges of a rail support although it could also be mounted on the inside. The advantage to mounting it on the outside is that it is more accessible to a user and also easier to draw for purpose of illustrating functionality as seen in FIG. 3. Mounting the kickstand on the inside makes it more difficult for a user to flip the kickstand open, but also protects the kickstand. The kickstand feet can be angled outwards for greater stability, as shown in FIG. 2. The skate cart stands upright on three points; the two points of the kickstand and the rear wheel. Two springs pull against the kickstand to bias it in open position.

FIG. 1 shows the kickstand 11 in open position, and the kickstand in closed position 12. When the kickstand is closed 11, the springs 13 bias it in closed position. The preferable spring orientation is to allow an equilibrium spring position where the kickstand is angled at a 45 degrees angle compared to the frame of the skate cart. The kickstand should also have a grippy bottom surface (also called grippy feet) to better contact and hold the ground.

The kickstand should also have a crossbar support to give structural rigidity to the kickstand. The crossbar support is positioned so that it clears the end of the support rail FIG. 1, 12. The kickstand biasing means can also be springs mounted collinearly with the pin joint of the kickstand.

1. A skate cart comprising: a frame, a front wheel and a rear wheel respectively connected to two ends of said frame, a handlebar assembly operationally connected to said front wheel, and
a kickstand mounted to said frame with a bolt at a first end to allow a user to flip open said kickstand, at least one spring attached to said kickstand at a first spring end and attached to the frame at a second spring end, wherein said at least one spring biases said kickstand open when the kickstand is in open position and wherein said at least one spring biases said kickstand closed when the kickstand is in closed position.

2. The skate cart of claim 1 wherein said frame has a deck supported by a U shaped support rail, wherein said kickstand is mounted inside a cavity formed by said U shaped support rail, and wherein said at least one spring is mounted inside said cavity formed by said U shaped support rail.

3. The skate cart of claim 1 wherein said frame has a deck supported by a U shaped support rail, wherein said kickstand is mounted outside a cavity formed by said U shaped support rail.

4. The skate cart of claim 1 further comprising grippy feet that attach to the kickstand at a second end opposite said first end, whereby said second end with grippy feet contacts the ground to support the skate cart.

5. A skate cart comprising: a frame, a front wheel and a rear wheel respectively connected to two ends of said frame, a handlebar assembly operationally connected to said front wheel, and
a kickstand mounted to said frame with a bolt at a first end to allow a user to flip open said kickstand, at least one spring mounted collinear to an axis parallel to said bolt and connected to said kickstand at a first spring end and attached to the frame at a second spring end, wherein said at least one spring biases said kickstand open when the kickstand is in open position and wherein said at least one spring biases said kickstand closed when the kickstand is in closed position.

6. The skate cart of claim 1 wherein said frame has a deck supported by a U shaped support rail, wherein said kickstand is mounted inside a cavity formed by said U shaped support rail, and wherein said at least one spring is mounted inside said cavity formed by said U shaped support rail.

7. The skate cart of claim 1 wherein said frame has a deck supported by a U shaped support rail, wherein said kickstand is mounted outside a cavity formed by said U shaped support rail.

8. The skate cart of claim 1 further comprising grippy feet that attach to the kickstand at a second end opposite said first end, whereby said second end with grippy feet contacts the ground to support the skate cart.
